(19) United States
(12) Patent Application Publication
(10) Pub. No.: US 2016/0218347 A1
(43) Pub. Date: Jul. 28, 2016

(54) SECONDARY BATTERY

(71) Applicant: Samsung SDI Co., Ltd., Yongin-si (KR)

(72) Inventors: Mooryong BAEK, Yongin-si (KR); Insoo PARK, Yongin-si (KR)

(21) Appl. No.: 14/728,094

(22) Filed: Jun. 2, 2015

(30) Foreign Application Priority Data
Jan. 28, 2015 (KR) 10-2015-0013526

(51) Int. Cl. H01M 2/34; H01M 10/04

(52) U.S. Cl. CPC H01M 2/348; H01M 10/0431

(57) ABSTRACT

Provided is a secondary battery, which has increased reliability by providing a stable connection structure of a temperature sensitive element. The secondary battery includes an electrode assembly formed by winding a positive electrode plate, a negative electrode plate and a separator and including a pair of lead tabs drawn from the positive electrode plate and the negative electrode plate, a pouch sealing the electrode assembly and including a terrace portion exposing the lead tabs to the outside, a temperature sensitive element formed in the terrace portion and electrically connected to the lead tabs, and a movement preventing tape formed in the terrace portion to cover the temperature sensitive element.

### RELATED APPLICATIONS

This application claims priority from Korean Patent Application No. 10-2015-0013526 filed on Jan. 28, 2015 in the Korean Intellectual Property Office, and all the benefits accruing therefrom under 35 U.S.C. 119, the contents of which in its entirety are herein incorporated by reference.

### BACKGROUND

1. Field

The present invention relates to a secondary battery, which has increased reliability by providing a stable connection structure of a temperature sensitive element.

2. Description of the Related Art

In general, unlike primary batteries which are not rechargeable, secondary batteries can be charged and discharged. Low-capacity secondary batteries each having a single battery cell packaged in the form of a pack are widely employed in small sized portable electronic devices, such as smart phones, tablet computers, and digital cameras while large-capacity secondary batteries having several tens to several hundreds of battery cells connected to one another are typically used for driving motors of electric bicycles, electric scooters, electric automobiles or hybrid automobiles.

Secondary batteries are manufactured in various shapes, including, for example, prismatic type, cylindrical and pouch types. A secondary battery includes an electrode assembly having positive and negative electrodes and a separator interposed between the positive and negative electrodes, and a case for receiving the electrode assembly with an electrolyte.

### SUMMARY OF CERTAIN INVENTIVE ASPECTS

The present invention provides a secondary battery, which has increased reliability by providing a stable connection structure of a temperature sensitive element.

The above and other objects of the present invention will be described in or be apparent from the following description of the preferred embodiments.

According to an aspect of the present invention, there is provided a secondary battery including an electrode assembly formed by winding a positive electrode plate, a negative electrode plate and a separator and including a pair of lead tabs drawn from the positive electrode plate and the negative electrode plate, a pouch sealing the electrode assembly and including a terrace portion exposing the lead tabs to the outside, a temperature sensitive element formed in the terrace portion and electrically connected to the lead tabs, and a movement preventing tape formed in the terrace portion to cover the temperature sensitive element.

The movement preventing tape may be formed to cover the lead tabs adjacent thereto together with the temperature sensitive element.

The movement preventing tape may extend to cover at least a portion of a top portion of the terrace portion.

One end of the temperature sensitive element may be coupled to one of the lead tabs and the other end of the temperature sensitive element may be coupled to a connection tab.

The movement preventing tape may be formed to cover the lead tabs and the connection tab together with the temperature sensitive element.

The movement preventing tape is made of a flame retardant material.

The movement preventing tape may include a Nomex tape.

The secondary battery may further include a shock absorbing tape formed on the movement preventing tape.

The shock absorbing tape may be formed to cover the temperature sensitive element.

The shock absorbing tape may be formed between an external protective circuit module and the temperature sensitive element.

The shock absorbing tape may be made of a flame retardant material.

The shock absorbing tape may include a Poron tape.

As described above, the secondary battery according to the present invention can secure stability and reliability by preventing movement of a temperature sensitive element by fixing a top portion of the temperature sensitive element to a terrace portion of a pouch using a movement preventing tape.

In addition, the secondary battery according to the present invention includes a shock absorbing tape surrounding the temperature sensitive element along a terrace portion, thereby absorbing external shocks transferred to a temperature sensitive element and reducing noises by filling a space between the shock absorbing tape and a protective circuit module positioned thereon.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a secondary battery according to an embodiment of the present invention;

FIG. 2 is an exploded perspective view illustrating a state in which an electrode assembly is inserted into a pouch case in the secondary battery according to an embodiment of the present invention;

FIG. 3 is an enlarged view of a portion A of FIG. 1;

FIG. 4 is an exploded perspective view illustrating a state in which a movement preventing tape is coupled in the secondary battery according to an embodiment of the present invention;

FIG. 5 is a cross-sectional view taken along the line B-B′ of FIG. 1;

FIG. 6 is a perspective view illustrating a state in which a shock absorbing tape is coupled in the secondary battery according to another embodiment of the present invention;

FIG. 7 is an exploded perspective view illustrating a state in which a shock absorbing tape is coupled in the secondary battery according to another embodiment of the present invention; and

FIG. 8 is a cross-sectional view taken along the line C-C′ of FIG. 6.

### DETAILED DESCRIPTION OF CERTAIN INVENTIVE EMBODIMENTS

Hereinafter, examples of embodiments of the invention will be described in detail with reference to the accompanying drawings such that they can easily be made and used by those skilled in the art.

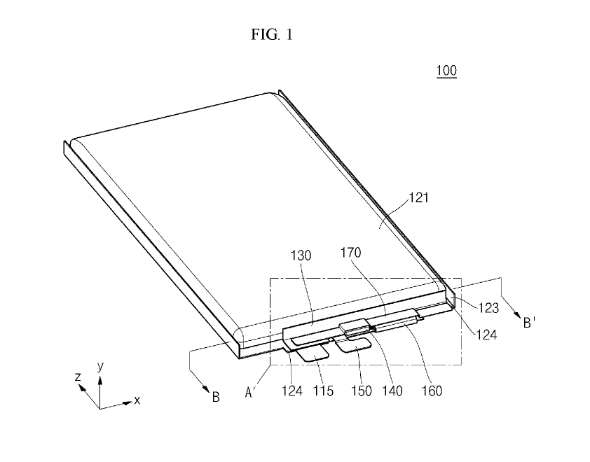

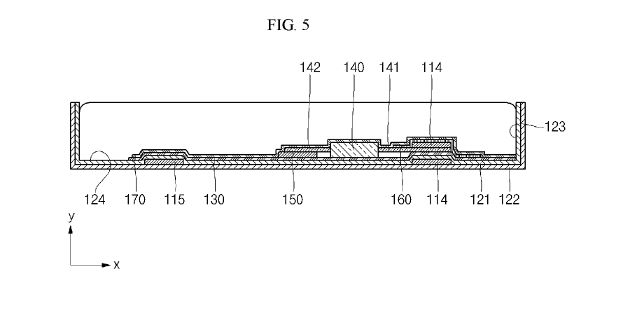

Referring to FIGS. 1 to 5, the secondary battery 100 according to an embodiment of the present invention may include an electrode assembly 110, a pouch 120, a first insulating tape 130, a temperature sensitive element 140, a connection tab 150, a second insulating tape 160, and a movement preventing tape 170.

The electrode assembly 110 is formed in a jelly roll configuration in which a first electrode plate 111 and a second electrode plate 112 are wound with a separator 113 interposed therebetween. The first electrode plate 111 may be a positive electrode plate and the second electrode plate 112 may be a negative electrode plate. When necessary, polarities of the electrode plates 111 and 112 may be reversed. For sake of convenient explanation, the following description will be made with regard to a case where the first electrode plate 111 is a positive electrode and the second electrode plate 112 is a negative electrode.

The first electrode plate 111 is formed by coating a first electrode active material, such as a transition metal oxide, on a first electrode current collector formed of a metal foil made of aluminum. The first electrode plate 111 may include an uncoated portion that is not coated with the first electrode active material. The uncoated portion provides a path of the flow of current between the first electrode plate 111 and the outside. Meanwhile, the present invention does not limit the material of the first electrode plate 111 to that disclosed therein.

In addition, a first lead tab 114 may be formed on the uncoated portion of the first electrode plate 111. The first lead tab 114 establishes a path for inputting/outputting an electrical signal of the first electrode plate 111.

The second electrode plate 112 is formed by coating a second electrode active material, such as graphite or carbon, on a second electrode current collector formed of a metal foil made of copper or nickel. The second electrode plate 112 may include an uncoated portion that is not coated with the second electrode active material.

In addition, a second lead tab 115 may be formed on the uncoated portion of the second electrode plate 112. The second lead tab 115 establishes a path for inputting/outputting an electrical signal of the second electrode plate 112.

The separator 113 is interposed between the first electrode plate 111 and the second electrode plate 112 for preventing a short circuit therebetween and for allowing movement of lithium ions therebetween. In addition, the separator 113 may be formed of polyethylene (PE), polypropylene (PP), or a composite film of PE and PP. In other embodiments, the material of the separator 113 is not limited thereto.

The electrode assembly 110 is accommodated in the case 120 with electrolyte. The electrolyte may include an organic solvent such as ethylene carbonate (EC), propylene carbonate (PC), diethyl carbonate (DEC), ethyl methyl carbonate (EMC), or dimethyl carbonate (DMC), and a lithium salt such as LiPF₆ or LiBF₄. In addition, the electrolyte can be a liquid, solid, and/or gel electrolyte.

In addition, insulation members 116 and 117 may be coupled to regions where the first lead tab 114 and the second lead tab 115 are coupled to the pouch 120. The insulation members 116 and 117 may electrically insulate the pouch 120 from the lead tabs 114 and 115.

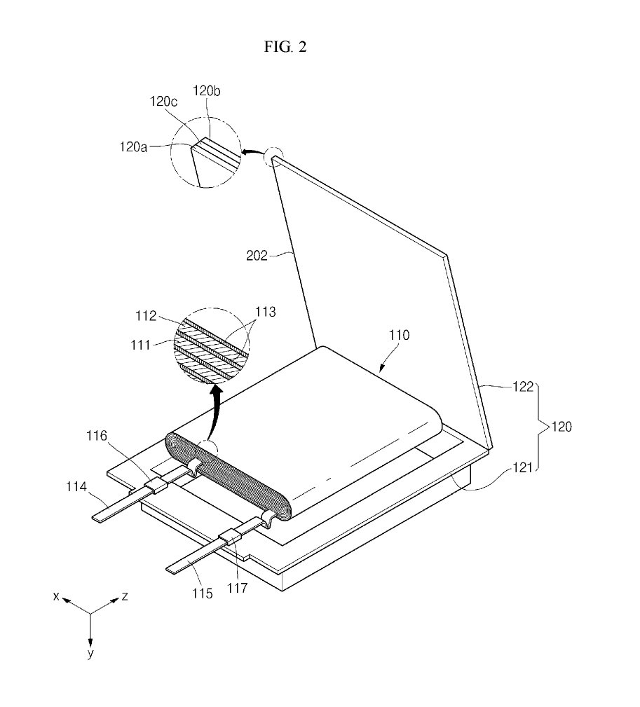

The pouch 120 may be formed in a multi-layered sheet structure surrounding the electrode assembly 110. Referring to FIG. 2, the pouch 120 includes a polymer sheet 120a forming an inner surface and performing insulation and thermal fusion, a sheet 120b made of polyethyleneterephthalate (PET), nylon or a combination of PET and nylon (to be described hereinafter with regard to a “nylon sheet” by way of example), and a metal sheet 120c for providing mechanical strength. The metal sheet 120c is interposed between the polymer sheet 120a and the nylon sheet 120 and may include, for example, an aluminum sheet.

In addition, the pouch 120 includes a first outer case 121 accommodating the electrode assembly 110 and a second outer case 122 covering the electrode assembly 110 and thermally fused to the first outer case 121 from the outside of the electrode assembly 110. Each of the first outer case 121 and the second outer case 122 may have the same configuration as the pouch 120. That is to say, each of the first outer case 121 and the second outer case 122 may include a polymer sheet 120a, a nylon sheet 120b and a metal sheet 120c.

For example, the first outer case 121 may be formed to have a concave structure so as to receive the electrode assembly 110 and the second outer case 122 may be planarly formed so as to cover the electrode assembly 110 received in the first outer case 121.

In addition, after the fusing of the pouch 120 in a state in which the electrode assembly 110 is received in an internal space formed by combining the first outer case 121 and the second outer case 122 with each other, the pouch 120 may include a bent portion 123 formed along its fused edge and a terrace portion 124.

The bent portion 123 is formed by bending fused regions by about 90°, the fused regions formed along opposite side surfaces of the first outer case 121 and the second outer case 122 when the first outer case 121 and the second outer case 122 are combined with each other. The bent portion 123 is formed to have substantially the same thickness with the first outer case 121 including the electrode assembly 110.

The terrace portion 124 is formed at regions from which the lead tabs 114 and 115 of the electrode assembly 110 are drawn. The terrace portion 124 may be fused in a state in which the lead tabs 114 and 115 are further drawn to the outside, and may fix positions of the lead tabs 114 and 115. In addition, the terrace portion 124 is not bent, forming a predetermined region, unlike the bent portion 123. Accordingly, the temperature sensitive element 140 and a protective circuit module (not shown) are mounted on the terrace portion 124.

The first insulating tape 130 is bent in about 90°, forming an ‘L’ letter configuration. The first insulating tape 130 is formed along a region of the terrace portion 124 in a horizontal direction and is formed to cover the thickness of the first outer case 121 in a vertical direction. The first insulating tape 130 insulates the temperature sensitive element 140 and the connection tab 150 from the pouch 120. In addition, when the first insulating tape 130 is a double-sided tape, it can physically attach the temperature sensitive element 140 and the connection tab 150 to the pouch 120.

One end 141 of the temperature sensitive element 140 is connected to the first lead tab 114 and the other end 142 of the temperature sensitive element 140 is connected to the connection tab 150. Therefore, the current generated from the electrode assembly 110 passes through the temperature sensitive element 140. In addition, when a temperature of the secondary battery 100 according to an embodiment of the present invention exceeds a predetermined reference temperature, the temperature sensitive element 140 cut offs the current, thereby preventing an abnormal phenomenon occurring due to heat generated from the secondary battery 100. To this end, the temperature sensitive element 140 may include a positive temperature coefficient (PTC). In addition, the temperature sensitive element 140 may be a chip PTC thermistor that is surface mountable, but the present invention does not limit the kind of the temperature sensitive element 140 to that disclosed therein. In an example, the temperature sensitive element 140 may have operating characteristics, such as resistance of several hundreds of ohms at room temperature, or an operating temperature in a range of 75 to 120° C.

The connection tab 150 is connected to the one end 141 of the temperature sensitive element 140 and is fixed to the terrace portion 124 of the pouch 120. The connection tab 150 is connected to the first lead tab 114 through the temperature sensitive element 140 to have the same polarity as the first lead tab 114. In addition, the connection tab 150 is connected to an external protective circuit module (not shown) to then be used in charging/discharging operation of the secondary battery 100 according to an embodiment of the present invention.

The second insulating tape 160 may insulate the one end 141 of the temperature sensitive element 140 connected to the first lead tab 114 from the outside. In addition, the second insulating tape 160 may be integrally formed with the first insulating tape 130 according to the choice of one skilled in the art. In addition, the second insulating tape 160 may fix the one end 141 of the temperature sensitive element 140, thereby fixing the position of the temperature sensitive element 140 on the terrace portion 124.

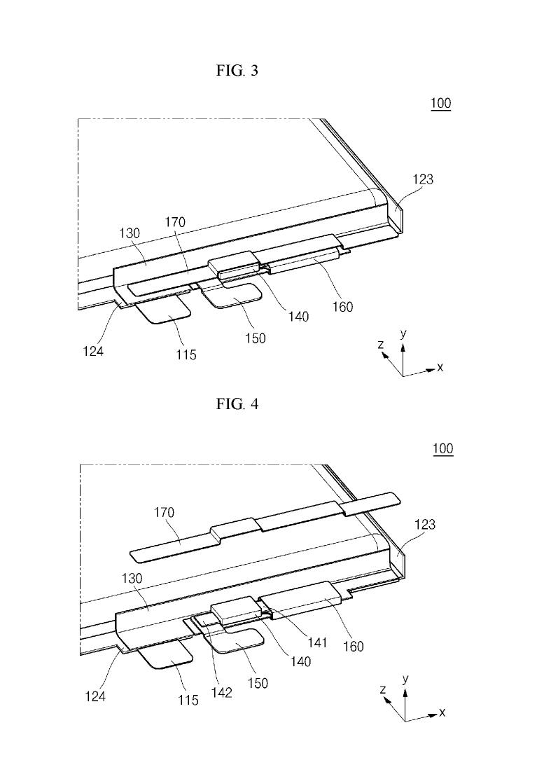

The movement preventing tape 170 is provided in a substantially band-like shape and is formed on the terrace portion 124 along the lengthwise direction of the terrace portion 124. The movement preventing tape 170 fixes the position of the temperature sensitive element 140 on the terrace portion 124. To this end, referring to FIGS. 3 and 4, along with the temperature sensitive element 140, the movement preventing tape 170 is formed to surround top portions of the second lead tab 115, the connection tab 150 and the second insulating tape 160, positioned around the movement preventing tape 170. In addition, the movement preventing tape 170 extends to one side of the terrace portion 124. Therefore, since the position of the movement preventing tape 170 is stably fixed on the terrace portion 124, it can prevent or inhibit the temperature sensitive element 140 from moving even due to external shocks.

In addition, in order to achieve stability, the movement preventing tape 170 is preferably made of a flame retardant material. In order to increase operator's working efficiency, the movement preventing tape 170 is preferably formed to have an appropriate thickness and strength. The movement preventing tape 170 may include a Nomex™ brand tape (available from Nitto Denko Corp at Osaka, Japan). Here, Normax is an aramid fiber or an aromatic polyimde fiber, which has high heat resistance and good flame retardancy. It is also known that the Normax has excellent strength and durability. Accordingly, the Nomex tape using Normax is suitably used as the movement preventing tape 170.

In addition, owing to the presence of the movement preventing tape 170, the first insulating tape 130 may be optionally removed according to the choice of one skilled in the art. In this case, the secondary battery 100 according to an embodiment of the present invention can reduce the manufacturing cost and can reduce man-hours.

Therefore, in the secondary battery 100 according to an embodiment of the present invention, a top portion of the temperature sensitive element 140 is fixed on the terrace portion 124 of the pouch 120 using the movement preventing tape 170, thereby preventing the temperature sensitive element 140 from moving and ultimately securing stability and reliability.

Hereinafter, a configuration of a secondary battery according to another embodiment of the present invention will be described.

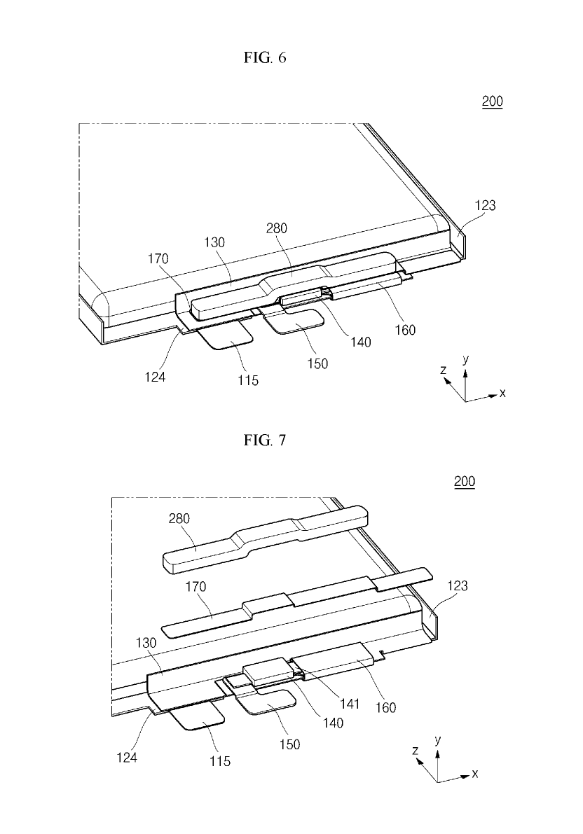

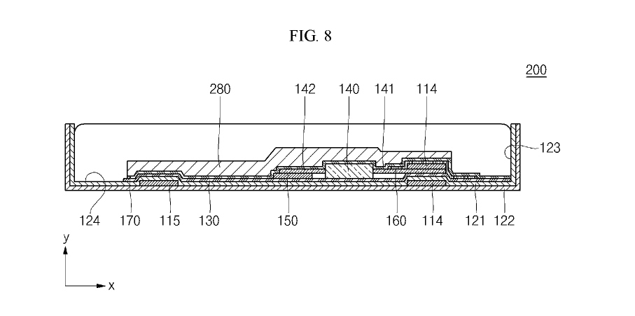

FIG. 6 is a perspective view illustrating a state in which a shock absorbing tape is coupled in the secondary battery according to another embodiment of the present invention, FIG. 7 is an exploded perspective view illustrating a state in which a shock absorbing tape is coupled in the secondary battery according to another embodiment of the present invention, and FIG. 8 is a cross-sectional view taken along the line C-C′ of FIG. 6.

Referring to FIGS. 6 to 8, the secondary battery 200 according to another embodiment of the present invention includes an electrode assembly 110, a pouch 120, a first insulating tape 130, a temperature sensitive element 140, a connection tab 150, a second insulating tape 160, a movement preventing tape 170, and a shock absorbing tape 280. The same functional components as those of the previous embodiment are denoted by the same reference numerals, and the following description will focus on differences between the present and previous embodiments.

The shock absorbing tape 280 is formed on the movement preventing tape 170. The shock absorbing tape 280 is formed along a terrace portion 124 so as to surround top portions of the second lead tab 115, the connection tab 150 and the second insulating tape 160 together with a temperature sensitive element 140. Therefore, the shock absorbing tape 280 may more stably fix a position of the temperature sensitive element 140 on the terrace portion 124.

In addition, when an external shock is applied to the secondary battery 200 according to another embodiment of the present invention, the shock absorbing tape 280 absorbs at least some of the shock transferred to the temperature sensitive element 140. In addition, the shock absorbing tape 280 may function to fill a space formed between the temperature sensitive element 140 and a protective circuit module (not shown) formed thereon. Accordingly, the shock transferred to the temperature sensitive element 140 may be absorbed and noises generated due to the presence of the space may be eliminated.

In order to secure stability, the shock absorbing tape 280 is preferably made of a flame retardant material. The shock absorbing tape 280 may include a Poron™ brand tape (available from the Rodgers Corporation of Rodgers Conn.). Here, Poron refers to a high-density polyurethane foam and is a flame retardant material that is highly capable of absorbing shocks. The Poron is suitably used as the shock absorbing tape 280.

Therefore, the secondary battery 200 according to another embodiment of the present invention includes the shock absorbing tape 280 surrounding the temperature sensitive element 140 along the terrace portion 124, thereby absorbing an external shock transferred to the temperature sensitive element 140 when the external shock is applied, and eliminating noises by filling the space between the temperature sensitive element 140 and the protective circuit module positioned thereon.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A secondary battery comprising:
an electrode assembly formed by winding a positive electrode plate, a negative electrode plate and a separator and including a pair of lead tabs drawn from the positive electrode plate and the negative electrode plate;
a pouch sealing the electrode assembly and including a terrace portion exposing the lead tabs to the outside;
a temperature sensitive element formed in the terrace portion and electrically connected to the lead tabs; and
a movement preventing tape formed in the terrace portion to cover the temperature sensitive element.

2. The secondary battery of claim 1, wherein the movement preventing tape is formed to cover the lead tabs adjacent thereto together with the temperature sensitive element.

3. The secondary battery of claim 1, wherein the movement preventing tape extends to cover at least a portion of a top portion of the terrace portion.

4. The secondary battery of claim 1, wherein one end of the temperature sensitive element is coupled to one of the lead tabs and the other end of the temperature sensitive element is coupled to a connection tab.

5. The secondary battery of claim 4, wherein the movement preventing tape is formed to cover the lead tabs and the connection tab together with the temperature sensitive element.

6. The secondary battery of claim 1, wherein the movement preventing tape is made of a flame retardant material.

7. The secondary battery of claim 1, wherein the movement preventing tape includes a Nomex™ brand tape.

8. The secondary battery of claim 1, further comprising a shock absorbing tape formed on the movement preventing tape.

9. The secondary battery of claim 8, wherein the shock absorbing tape is formed to cover the temperature sensitive element.

10. The secondary battery of claim 8, wherein the shock absorbing tape is formed between an external protective circuit module and the temperature sensitive element.

11. The secondary battery of claim 8, wherein the shock absorbing tape is made of a flame retardant material.

12. The secondary battery of claim 8, wherein the shock absorbing tape includes a Poron™ brand tape.
